(19) United States
(12) Patent Application Publication
(10) Pub. No.: US 2014/0333808 A1
(43) Pub. Date: Nov. 13, 2014

(54) Customizable Image Acquisition Sensor and Processing System

(71) Applicant: BAE SYSTEMS IMAGING SOLUTIONS, INC., Nashua, NH (US)

(72) Inventors: Boyd Fowler, Sunnyvale, CA (US); Xinqiao Liu, Mountain View, CA (US)

(73) Assignee: BAE Systems Imaging Solutions, Inc., Nashua, NH (US)

(21) Appl. No.: 13/892,178

(22) Filed: May 10, 2013

(51) Int. Cl. H04N 5/335

(52) U.S. Cl. CPC H04N 5/335
USPC 348/294

(57) ABSTRACT

An image sensor that includes a first imaging array and a FPGA processor that processes images captured by the imaging array to provide information about the scene projected on the first imaging array is disclosed. The FPGA processor is connected to the first imaging array and includes an interface for receiving images from the first imaging array and an interface to an image storage memory that stores a plurality of images. The FPGA implements a plurality of image processing functions in the gates of the FPGA. The image processing functions processing one of the images stored in the image storage memory to extract a quantity related to the one of the images. The FPGA also includes an I/O interface used by the FPGA to output the quantity to a device external to the image sensor.

### BACKGROUND

With the decrease in cost of CMOS imaging chips and computer computational hardware, commercially viable sensors based on optical pattern recognition are now possible. An optical pattern recognition sensor acquires an image from an imaging array and processes that image to provide information contained in the image other than the image itself. For example, a class of computer pointing devices commonly referred to as an “optical mouse” take a succession of pictures of the surface on which the pointing device moves. By comparing successive pictures, the computational hardware associated with the pointing device determines the direction and distance the pointing device has moved between the pictures in question and transmits that data to the computer formatted in a manner that emulates a conventional “mouse”. The user never sees the images taken by the camera in the mouse. Only the final movement information is relayed to the computer which uses the information to move a cursor on the computer screen. Such devices are sold in very large numbers, and hence, the cost is less than the mechanical mice that were previously used.

Unfortunately, many potential applications for optical pattern recognition systems do not have sufficient volume to justify the design costs and product development times that allowed the optical mouse to become widely used. Different applications often require different optical imaging arrays both in terms of the number of pixels, the spectral sensitivity of the pixels, and the optical imaging arrangement needed to project the image onto the imaging array. Some applications may require a plurality of imaging arrays with different sensitivities to generate the images needed.

In addition, the type of processing engine that is needed to process the image in the time frame allowed by the application varies from application to application. Some applications may require a large number of relatively simple processors to work on the image in parallel. Other applications require special purpose hardware to generate correlation values between images. In the currently available systems, the system designer is left with the task of programming the processing engine starting from the raw images generated by the optical sensor. Hence, the programming task is expensive and adds significantly to the product development time.

Debugging an optical pattern recognition system also presents challenges in low volume applications. The programmer often needs to see several internally stored images that may include calculated images. The programmer needs to see what the optical pattern recognition system “saw” and calculated to determine where the programming has failed. The specific images change from application to application. Conventional programming debugging tools are optimized for linear arrays of data. However, images are inherently two-dimensional objects.

### SUMMARY

The present invention includes an image sensor that includes a first imaging array and a field programmable gate array (FPGA) processor that processes images captured by the imaging array to provide information about the scene projected on the first imaging array. The FPGA processor is connected to the first imaging array and includes an interface for receiving images from the first imaging array and an interface to an image storage memory that stores a plurality of images. The I-PGA implements a plurality of image processing functions in the gates of the FPGA. The image processing functions processes one of the images stored in the image storage memory to extract a quantity related to the one of the images. The FPGA also includes an I/O interface used by the FPGA to output the quantity to a device external to the image sensor.

In one aspect of the invention, an I/O interface is operated by the FPGA to output selected images in the image storage memory in a format that mimics that of a digital camera. This arrangement simplifies the task of debugging imaging algorithms performed by the FPGA.

In another aspect of the invention, the interface for receiving images from the first imaging array includes a memory bus. The first imaging array mimics a conventional computer memory in this aspect of the invention. The first imaging array outputs an image captured therein in response to read commands on the memory bus. One of the types of commands sent by the FPGA on the memory bus includes a memory address and data to be stored in that address. The first imaging array interprets one of the commands as a control command for the first imaging array if the address corresponds to a predetermined address associated with the first imaging array.

In another aspect of the invention, one of the received images is stored in the image storage memory and the FPGA has a command that causes images stored in the image storage memory to be output in a format that mimics a convention digital camera.

In another aspect of the invention, a light source controlled by the FPGA is included in the imaging sensor and is available to illuminate a scene recorded by the image sensor. The light source can be a narrow wavelength source such as a laser having a wavelength that is selectively reflected by a portion of a scene that is viewed by the first imaging array. The quantity determined by the image sensor can be related to the portion of the scene that reflects the light from the light source.

In yet another aspect of the invention, the image sensor includes a second imaging array having a different spectral response than the first imaging array, the quantity being determined by a first image from the first imaging array and a second image from the second imaging array.

### BRIEF DESCRIPTION OF THE DRAWINGS

FIG. 1 illustrates one embodiment of a customizable image sensor according to the present invention.

FIG. 2 illustrates an image sensor that includes two imaging arrays.

FIG. 3 is a block diagram of a control chip according to one embodiment of the present invention.

FIG. 4 illustrates an imaging array according to one embodiment of the present invention.

FIG. 5 illustrates another embodiment of an image sensor according to the present invention.

### DETAILED DESCRIPTION

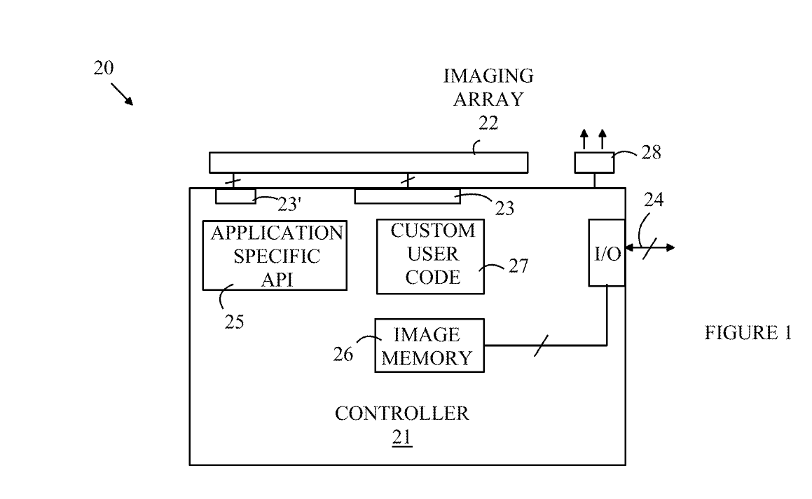

The manner in which the present invention provides its advantages can be more easily understood with reference to FIG. 1, which illustrates one embodiment of a customizable image sensor according to the present invention. Image sensor 20 includes a controller 21 that can be customized for specific pattern recognition problems and an imaging array 22. Imaging array 22 is selected from a plurality of imaging arrays that are designed to be connected to controller 21.

In one aspect of the invention, imaging array 22 is coupled to controller 21 by an interface 23 that includes a memory interface. When viewed by controller 21, imaging array 22 emulates a conventional memory array. Imaging array 22 utilizes a second code storage area 23′ that controls the acquisition of an image. Once the image is acquired, the image is readout as if the imaging array were a conventional read-only memory. Different imaging arrays could have different numbers of pixels and array configurations in terms of the number of rows and columns of pixels; however, all of these are readout as if they were a memory having a word size that is determined by the number of columns and a capacity determined by the number of rows. In another aspect of the invention, imaging array 22 is directly bonded to controller 21, and the memory bus is configured to use a word size that is large enough to accommodate all of the columns in the largest imaging array that is designed to be attached to controller 21. This arrangement takes advantage of existing memory interfaces for controllers such as FPGAs.

In another aspect of the invention, image sensor 20 includes a light source 28 that is chosen from a plurality of predefined light sources. Light source 28 can include a plurality of component light sources having different intensities and output spectra. Controller 21 includes an interface for driving the chosen light source. In many applications, the pattern recognition task can be simplified by using a specific light source for viewing the scene through imaging array 22. For example, light source 28 could include two component sources that emit light in different spectral regions. The spectral regions are chosen such that a difference image created by subtracting the image formed with a first light source from the image formed with a second light source can provide an enhancement of the objects of interest relative to background objects that are not of interest.

For example, consider a case in which the object of interest fluoresces when illuminated with light in the blue portion of the spectrum, but the background objects do not fluoresce when so illuminated. A difference image taken with light from a blue light source and light from a red light source will enhance the object of interest.

In another example, the object of interest has a reflective coating that reflects light in a narrow band of wavelengths around a first wavelength. Dichotic reflectors of this type are constructed by depositing alternating layers of transparent material having different refractive indices. A difference image with the first image taken with a laser diode that emits at the first wavelength and a second image utilizing a white light source will provide an enhanced view of the object of interest, and hence, facilitate pattern recognition tasks that depend on that object's shape or position.

Controller 21 includes an image memory 26 which holds a plurality of images. The images can include images taken by imaging array 22 or reference images that are input to controller 21 for the purposes of performing pattern recognition with respect to a library of images that are specific to the application for which image sensor 20 is being used. In one aspect of the invention, the images in image memory 26 are readout on I/O bus 24 in a manner that mimics a conventional digital camera. This allows a user to see the images captured by the camera and any intermediate images generated by the processing program in controller 21. By reproducing the format and control of a conventional digital camera, the software developed for that camera can be used to view the images and/or perform operations on the images using various image processing software packages. The user or designer can utilize these commercially available software tools to debug the program or experiment with various filtering algorithms that would improve the processing.

Controller 21 also includes a number of application specific hardware/software components. In one aspect of the invention, controller 21 includes an FPGA. A portion of the gates in controller 21 are arranged to provide hardware acceleration of certain image processing tasks. The specific components are specified when the designer specifies the contents of controller 21 in a manner that will be discussed in more detail below. Typically, a hardware accelerator includes an application program interface (API) that provides a high level function call to a user generated program. When the designer specifies one of the hardware accelerators, the corresponding API is loaded into the API storage area shown at 25. It should be noted, that APIs corresponding to other elemental image processing calculations that do not have a specific hardware accelerator can also be selected at design time and loaded in storage area 25.

In one aspect of the invention, controller 21 includes a user code storage area 27 that is used for storing specific programs that carry out the pattern recognition functions using the APIs and stored images. The code stored in code storage area 27 can be a compiled program that is input via I/O bus 24 or a script or high level program such as a basic program that is interpreted by code in controller 21. It should also be noted that code storage area 27 could include a combination of both types of code, with the designer providing a compiled operating program that calls a user defined script that is interpreted at runtime.

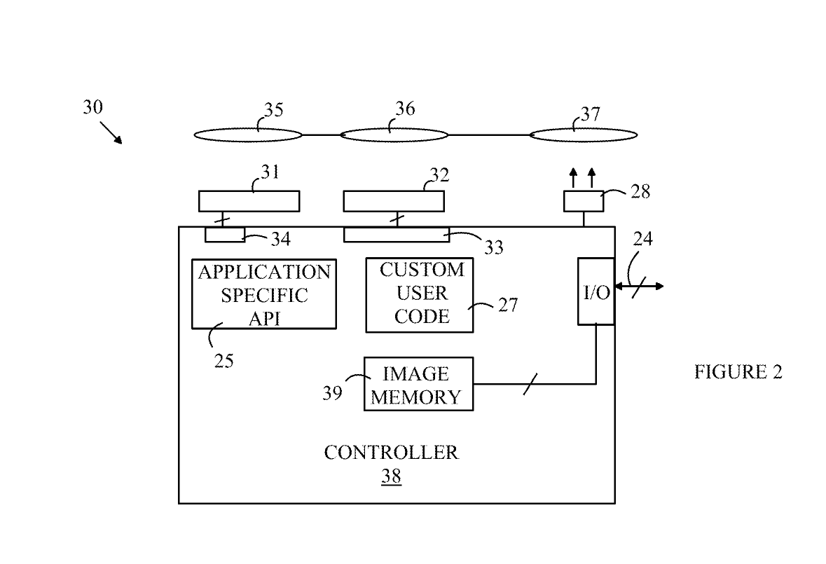

The above-described embodiments utilize a single imaging array. However, embodiments that utilize multiple imaging arrays can also be constructed. Refer now to FIG. 2, which illustrates an image sensor that includes two imaging arrays shown at 31 and 32. To simplify the following discussion, those components of image sensor 30 that perform functions analogous to those discussed above with reference to FIG. 1 have been given the same numeric designations and will not be discussed in detail here. Imaging arrays 31 and 32 are interfaced to controller 38 by memory interfaces 33 and 34 in a manner analogous to that described above. The non-memory control functions that are analogous to those provided by code storage area 27 discussed above have been included in the memory interfaces to simplify the drawing. Each of the imaging arrays generates images that are organized as memory arrays that are stored in image memory 39.

Image sensor 30 includes a lens array that includes imaging lenses 35 and 36 that project a scene on imaging arrays 31 and 32, respectively. Lens 37 collimates the light from light source 28 that illuminates the scene. The individual imaging arrays have different properties that improve the pattern recognition process. For example, imaging array 31 can have a different spectral response than imaging array 32. The different spectral responses together with different illumination spectra can more easily identify objects of interest than a system with just one imaging array.

In another example, imaging array 31 could have a much higher resolution than imaging array 32. In this case, initial pattern recognition computations could be carried out using imaging array 32, which, because of its lower resolution, and hence, fewer number of pixels, can be carried out more quickly. If the results of processing with imaging array 32 indicate that the scene is one of interest, the higher resolution image from imaging array 31 can be utilized to provide the final pattern match. For example, in an application in which the scene is being matched against a number of scenes in a library, an initial match can be performed quickly at the low resolution. If the results of the low resolution comparison indicate a possible match, the matching process can be repeated with the high resolution image.

As noted above, in an image sensor according to the present invention, the designer is presented with a number of high level image processing tools that are incorporated in the application specific APIs. For example, a tool that takes a weighted difference of two images in the image memory and stores the result in a third image in that memory is useful in many pattern recognition problems. In the present invention, a single command can execute the computation in question. Similarly, a tool that computes the correlation between two images with one image offset by a value input to the tool is useful in detecting moving scenes and aligning a scene with an image in an image library.

Another tool compresses an image using one of a plurality of image compression algorithms and stores the resultant image in another image in the image memory. This tool is useful in generating the output images that mimic a conventional digital camera.

The number of potentially useful tools is too large to provide every tool in every image sensor. In addition, the size of the image memory will depend on the specific application. A pattern recognition sensor that compares a scene to examples in a large library will require more image memory than a pattern recognition sensor that does not require a large library.

There is also a trade-off between the area of silicon devoted to image storage and the area of silicon that is devoted to computational hardware. Many image processing applications can benefit from parallel computing hardware. However, the cost of the controller is directly related to the area of silicon needed to implement the hardware and image storage. Hence, once again, a system that provides both large image memory and a large parallel computing processor may be economically problematic.

Finally, building a custom controller for each application is only economically feasible for applications having very large numbers of controllers. In many applications, the number of sensors is too small to justify a custom controller that is designed from the “ground up” to be optimal for the specific application.

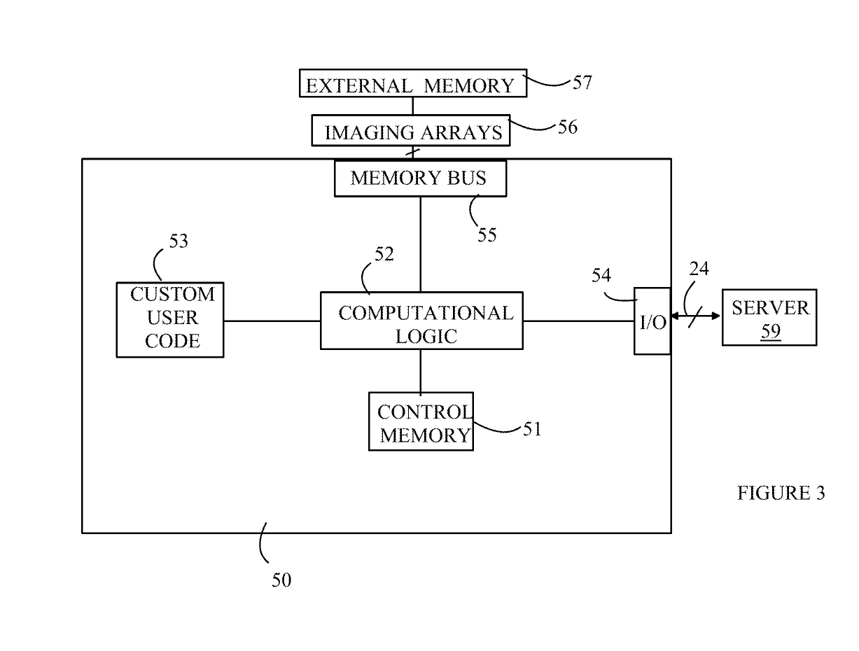

In one aspect of the invention, the controller includes a control chip and a number of modules that are external to the control chip. Refer now to FIG. 3, which is a block diagram of a control chip according to one embodiment of the present invention. The control chip provides computation and interface functions. Control chip 50 is an FPGA in one aspect of the invention. Control chip 50 provides the various interfaces to the imaging arrays and other components that are external to control chip 50. I/O interface 54 is provided for communication with the “outside” world. Control chip 50 also includes a memory bus interface 55 that is used to communicate with the imaging array(s) 56 and an external memory 57 that is used to store images such as library images for pattern matching. The advantages of this arrangement will be discussed in detail below. The FPGA can include a memory such as control memory 51 used by computational logic to store program instructions and/or intermediate results from the image processing.

Control chip 50 includes computational logic block 52 which includes a conventional CPU and operating system that execute programs in a user provided program that resides in custom code memory 53 area as well as performing the various functions required by the APIs and 110 interface. Control chip 50 also provides various hardware acceleration functions that are useful in image pattern recognition.

In one aspect of the invention, a plurality of different I/O interfaces are provided to the designer who chooses one or more of these interfaces for implementation in the specific image sensor being designed. These I/O interfaces may include wireless interfaces such as WiFi or Bluetooth interfaces as well as wired interfaces such as Ethernet connections. By limiting the number of actually implemented interfaces in a particular image sensor, additional silicon areas for other functions become available.

In one aspect of the invention, one or more of the hardware functions is implemented as an interface link to an external processor 59 or server that performs the function in response to receiving information from control chip 50. This link can be implemented by part of I/O interface 54 or utilize a separate link. The link to the external processor can include portions of the Internet or other networks and can be implement as an RF link or hardwired link. Control chip 50 transfers the necessary data to perform the required function, which typically requires significantly more computational bandwidth than the bandwidth available in the image sensor that is attached to control chip 50. The external processor then performs the computationally intensive function and returns the results to the image sensor or forwards the results to another external processor.

For example, the controller in the image processing system could execute object extraction algorithms on an acquired image and compress the images of the extracted objects. The compressed image of a potentially interesting object could then be sent to the external processor for identification. In general, the scene viewed by the image sensor has one or more objects of potential interest on a background. Since individual objects in a scene are typically more compressible than the scene containing those objects and the background, the amount of data that needs to be transmitted is significantly reduced compared to systems in which the entire image is compressed and sent to a server for processing.

In addition, only potentially interesting objects need to be sent to the external processor. For example, an object that has already been identified does not need to be sent a second time. Similarly, an object that moved between successive images is often of primary interest, and hence, communicated to the server for identification. If the identity of the object is already known, then the image sensor needs only to communicate information about the new placement of the object in the scene.

In a system having multiple image sensors that communicate with a central server that coordinates the activities of the individual image sensors, the central server could communicate data specifying an object to be detected. Each image sensor would then attempt to match that object with the objects extracted from the images viewed by that image sensor until the server terminates the requested search.

In one aspect of the invention, a memory interface that implements a memory bus that connects to a plurality of different memories is provided on the control chip. As noted above, the imaging arrays preferably mimic a memory when they provide an image to the control chip, as memory interfaces are a common well-defined interface in many different fabrication systems, including FPGAs. A memory bus allows multiple imaging arrays to be attached without specifying the number of memories in advance when the hardware is specified.

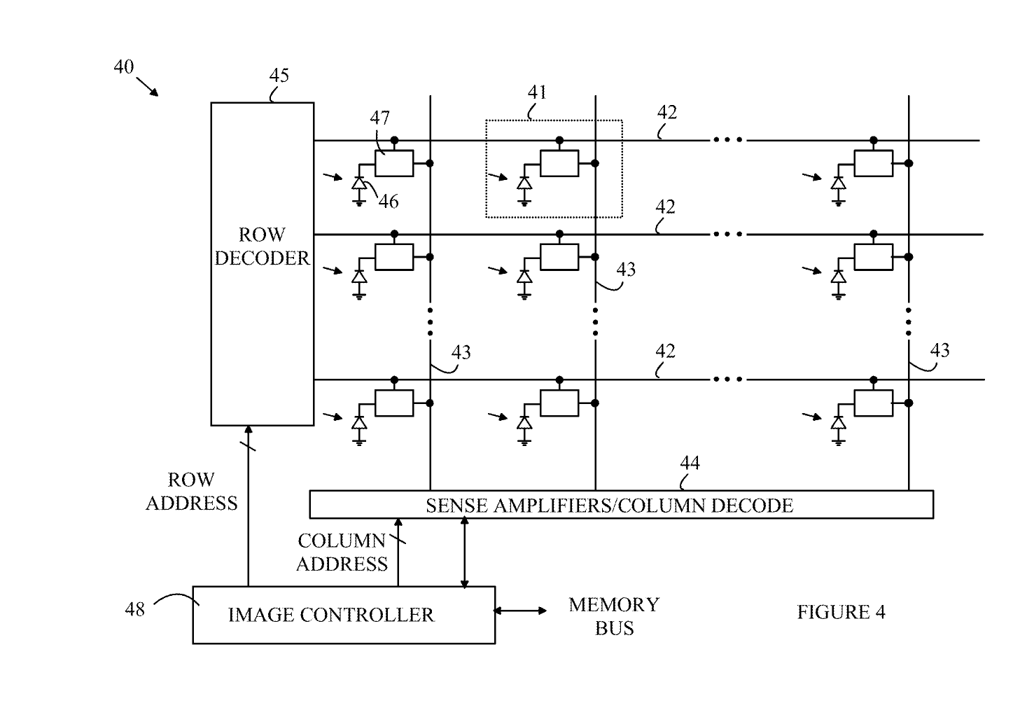

Refer now to FIG. 4, which illustrates an imaging array according to one embodiment of the present invention. Imaging array 40 is constructed from a rectangular array of pixel sensors 41. Each pixel sensor includes a photodiode 46 and an interface circuit 47. The details of the interface circuit depend on the particular pixel design. However, all of the pixel circuits include a gate that is connected to a row line 42 that is used to connect that pixel to a bit line 43. The particular row that is connected to the bit lines is determined by row decoder 45.

The various bit lines terminate in a column processing circuit 471 that typically includes sense amplifiers and column decoders. Each sense amplifier reads the signal produced by the pixel that is currently connected to the bit line processed by that sense amplifier and processes that signal to provide a digital value indicative of the light accumulated during an exposure.

The internal operation of imaging array 40 is controlled by an image controller 48. Image controller 48 is coupled to the memory bus discussed above with reference to FIG. 3. Image controller 48 stores a base address and emulates a conventional memory that stores data from that base address to some predetermined value that is large enough to accommodate all of the pixel values in imaging array 40. During a read operation on the memory bus, image controller 48 maps the address in the read request to a particular pixel in imaging array 40 and sets the row and column addresses accordingly. The contents of that pixel are then returned as the data from the read operation.

In embodiments in which all of the pixels are readout in parallel on a given row, the controller preferably requests data in an order that reflects this readout mode. In this case, a read command is sent with the address of the first pixel of the row that is to be readout. The image controller reads out that row and stores the results in the column decoder block shown at 44. The first stored pixel value is then returned. On subsequent read instructions to this row, the appropriate pixel value is then read directly from the stored values.

During image acquisition, each of the pixels must first be reset by removing any stored charge on the photodiode in that pixel. The image is then captured during a subsequent exposure period, and the accumulated photo charge in each pixel is transferred to a floating diffusion node in that pixel. An interface circuit in that pixel then reads out the voltage on that diffusion node via the corresponding bit line.

At a minimum, the controller must send an instruction to take a picture. If the imaging array does not have an automatic exposure control, the controller must also specify the exposure time. Alternatively, the controller could send separate reset, start, and stop commands to the imaging array. In any case, the controller must be able to communicate with the imaging array in a mode that is distinguishable from the mode in which the controller reads out the image.

In one aspect of the invention, the controller sends commands to the imaging array via write commands directed to a predetermined memory address or addresses within the address range associated with that imaging array. The data in the write command can be used to specify operating parameters such as the exposure time or readout protocol.

The use of a memory interface for communicating with the imaging array provides additional advantages during the development and debugging of the software for a specific application. To debug many applications, test images must be provided to the controller to determine if the software and controller hardware are functioning properly. While such test images can be generated by connecting an imaging array with an optical system that views a test scene, such test setups require a significant effort, particularly during early stages of software and hardware design.

To simplify the debugging process, the present invention makes use of the observation that a memory can likewise mimic an imaging array. In this aspect of the invention, the user stores one or more test images in a memory that is connected to the memory bus discussed above. The memory is given a base address that the software associates with an imaging array. The memory then provides the images to the software during debugging. Since exactly the same image is provided each time the software is run, problems with the software can be more easily determined than in embodiments in which the imaging array generates a new, and slightly different image, each time the software is run. Furthermore, the test images can generate intermediate images that are readout using the camera emulation mode discussed above. These intermediate images can be compared with the expected intermediate images to further isolate program and/or hardware problems.

In the above-described embodiments, the imaging array reads out the pixel values, one pixel at a time. However, embodiments in which multiple pixels are readout at once can also be constructed. In the limit, each row would be read out at once. These embodiments require a memory bus that is significantly wider than the standard memory buses. Wide memory buses can be more easily implemented in an arrangement in which the image sensor is bonded to a surface of the control chip.

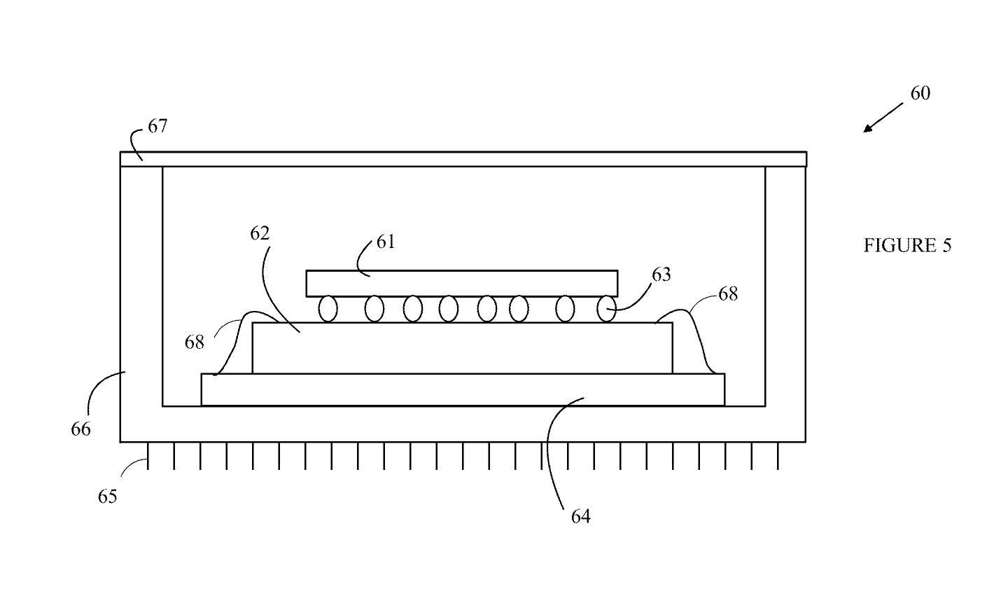

In one aspect of the invention, the control chip, imaging array, and optics are provided in a single package. Refer now to FIG. 5, which illustrates another embodiment of an image sensor according to the present invention. Image sensor 60 includes an imaging array 61 that is bonded to a control chip 62 by a plurality of solder bumps 63. Imaging array 61 is a thinned sensor that receives the image to be digitized via the surface opposite to that in which the circuitry is located. Control chip 62 is an FPGA that includes the logic and processors for controlling imaging array 61 and processing the images to extract the data of interest from a scene projected onto imaging array 61 through window 67. Image sensor 60 is a self-contained sensor that includes housing 66 that provides connections such as the I/O connections discussed above through a series of pins 65 that extend from the bottom of housing 66. Control chip 62 is connected to a packaging substrate 64 that provides the connections to pins 65. In this example, control chip 62 is connected to packaging substrate 64 by wire bonds 68.

The FPGA is connected to a standard SDRAM memory bus such as DDR2. In this configuration a 64 bit data bus is used to transfer data between the memory banks and the FPGA. A memory controller inside the FPGA is used to generate all the necessary clock and control signals used by the individual memory banks. Moreover, these signals enable specific memory banks and multiplex the row and column addressing. Each memory bank consists of several memory chips with additional logic used to control and manage the transfer of data to and from the memory bank. The clocking in this type of memory system is synchronous with the data transfer. When data is to be written or read from the memory bus the memory controller first selects the correct memory bank. Then it transmits the correct row and column address information to the memory, and finally the data is either written or readout of the memory bus. This process is then repeated as often as necessary for the specific application.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

What is claimed is:

1. An image sensor comprising:
an first imaging array that outputs an image of a scene projected onto said first imaging array;
a FPGA processor connected to said first imaging array, said FPGA processor comprising:
an interface for receiving images from said first imaging array;
an interface to an image storage memory that stores a plurality of images;
a plurality of image processing functions implemented in gates of said FPGA, said image processing functions processing one of said images stored in said image storage memory to extract a quantity related to said one of said images; and
an I/O interface used by said FPGA to output said quantity to a device external to said image sensor.

2. The image sensor of claim 1 wherein said I/O interfaces comprises a wireless interface link.

3. The image sensor of claim 1 wherein said FPGA processor communicates with an external processor that is external to said image sensor, said external processor performing a function based on information transmitted by FPGA processor and returning a result to said FPGA processor.

4. The image sensor of claim 3 wherein said FPGA processor extracts an image of an object and communicates that extracted image to said external processor, and said external processor returns information about said extracted image to said image sensor.

5. The image sensor of claim 1 wherein said an I/O interface is operated by said FPGA to output selected images in said image storage memory in a format that mimics that of a digital camera.

6. The image sensor of claim 1 wherein said interface for receiving images from said first imaging array comprises a memory bus and wherein said first imaging array mimics a conventional computer memory, said first imaging array outputting an image captured therein in response to read commands on said memory bus.

7. The image sensor of claim 6 wherein said FPGA sends commands on said memory bus, one of said commands indicating a memory address and data to be stored in that address and wherein said first imaging array interprets said one of said commands as a control command for said first imaging array if said address corresponds to a predetermined address associated with said first imaging array.

8. The image sensor of claim 1 wherein one of said received images is stored in said image storage memory.

9. The image sensor of claim 6 wherein said interface to said image storage memory comprises said memory bus.

10. The image sensor of claim 1 wherein said image storage memory is part of said FPGA.

11. The image sensor of claim 1 wherein said image storage memory is external to said FPGA.

12. The image sensor of claim 1 further comprising a light source controlled by said FPGA that illuminates a scene recorded by said image sensor.

13. The image sensor of claim 12 wherein said light source comprises a laser having a wavelength that is selectively reflected by a portion of a scene that is viewed by said first imaging array, said quantity being related to said portion of said scene.

14. The image sensor of claim 1 further comprising a second imaging array having a different spectral response than said first imaging array, said quantity being determined by a first image from said first imaging array and a second image from said second imaging array.

15. The image sensor of claim 1 wherein said imaging array is directly bonded to said FPGA.
